(19) United States
(12) Patent Application Publication
(10) Pub. No.: US 2009/0013472 A1
(43) Pub. Date: Jan. 15, 2009

(54) CHANNELED MAT

(75) Inventors: Adam J. Koffler, Minneapolis, MN (US); Jeff Hoang, Eagan, MN (US)

Correspondence Address: SCHWEGMAN, LUNDBERG & WOESSNER, P.A., P.O. BOX 2938, MINNEAPOLIS, MN, 55402, US

(73) Assignee: Wow Cushion Ltd.

(21) Appl. No.: 11/775,648

(22) Filed: Jul. 10, 2007

(51) Int. Cl. B68G 5/00

(52) U.S. Cl. 5/652.1; 5/740

(57) ABSTRACT

Embodiments of the invention relate to a channeled mat comprising a mat and one or more channels in the mat. Embodiments also relate to a method of making a channeled mat comprising forming a mat and forming one or more channels in the mat.

### TECHNICAL FIELD

Embodiments of the present invention relate to a channeled mat. More specifically, embodiments of the present invention relate to a channeled mat that can be utilized as a mat, bedding, pad, seat pad, furniture cushion and other applications, including, but not limited to footwear and insoles.

### BACKGROUND

Mats and bedding are used in numerous applications including user comfort for sitting, standing or lying down. Depending on the environment and material compositions, the mat or bedding may absorb moisture or block air flow, thus causing discomfort to the user. The mat or bedding design or material choice do not handle spills or liquid contact well, usually absorbing or pooling which may cause health issues in addition to discomfort.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a cross-sectional view of a channeled mat with asymmetrical protrusions, according to some embodiments.

FIG. 2 illustrates a cross-sectional view of a channeled mat with rectangular shaped protrusions, according to some embodiments.

FIG. 3 illustrates a perspective view of a channeled mat with rectangular protrusions, according to some embodiments.

FIG. 4 illustrates a perspective view of a channeled mat with reduced spacing between protrusions, according to some embodiments.

FIG. 5 illustrates a perspective view of a channeled mat with substantially no space between protrusions at the surface level, according to some embodiments.

FIG. 6 illustrates a perspective view of channeled mat with triangular shaped protrusions, according to some embodiments.

FIG. 7 illustrates a cross-sectional view a single layer channeled mat, according to some embodiments.

FIG. 8 illustrates a cross-sectional view of a dual-layered channeled mat, according to some embodiments.

FIG. 9 illustrates a perspective of a dual-layered channeled mat with channels in multiple dimensions, according to some embodiments.

FIG. 10 illustrates a perspective view of an open ended channeled mat, according to some embodiments.

FIG. 11 illustrates a perspective view of close ended channeled mat, according to some embodiments.

FIG. 12 illustrates a perspective view of an aqueduct channeled mat, according to some embodiments.

FIG. 13 illustrates a method of making a channeled mat, according to some embodiments.

### SUMMARY

Embodiments of the invention relate to a channeled mat comprising a mat and one or more channels in the mat. Embodiments also relate to a method of making a channeled mat comprising forming a mat and forming one or more channels in the mat.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Embodiments of the invention relate a channeled mat, such as channeled bedding. The channeled mat allows air flow to the portion of the user in contact with the mat and also channels fluid or moisture away from the surface of the mat. The channeled mat may support the head, body and limbs of a user and adjusts for higher and lower weighted areas of the user with the ability to disburse weight through compression and natural movement of the surface layer of the mat. The channeled mat has numerous uses, both for increased comfort and also for alleviating health or medical issues. The channeled mat may be used as bedding, as part of a mattress, wall covering, flooring, seating, exercise mat, portable mat, cushion, furniture, footwear and insoles, floatation device, camping mat, beach chair, etc. Depending on material and design, the channeled mat selectively can be water proof or liquid-absorbable, washable or non-washable, thermally stable or unstable, resistant to shrinkage or shrinkable, resistant to cracks or crackable, bendable or rigid, mold resistant or non-mold resistant, for example. Alternatively, the material choice and design may be customizable depending on the expected use. For increased functionality, the channeled mat may be adjacent to or coupled to an external device, such as a fan, blower or dryer, for example.

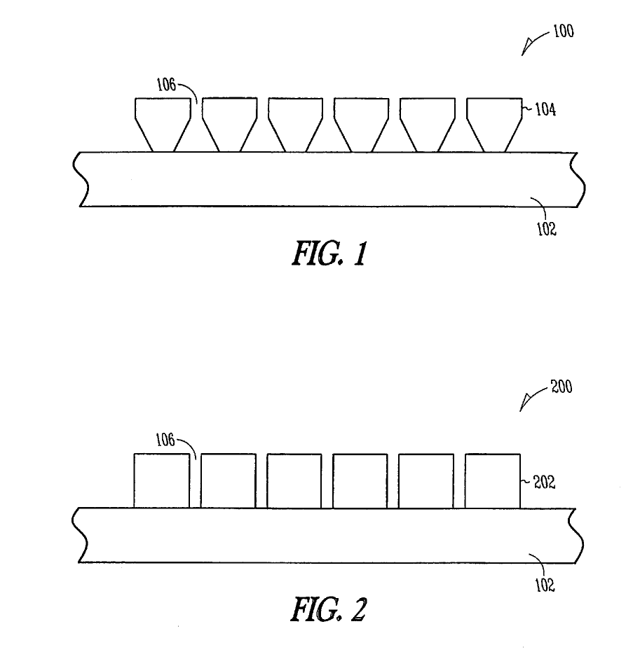

Referring to FIG. 1, a cross-sectional view of a channeled mat 100 with asymmetrical protrusions is shown, according to some embodiments. A base layer 102 may contact multiple protrusions 104. One or more channels 106 may be formed between and around the protrusions 104.

The base layer 102 may be formed as one unit with the protrusions 104, such as one-piece construction. One-piece construction may include the entire mat manufactured as one-piece construction, or repeating one-piece units in contact with one another, such as forming multiple levels or layers. The protrusions 104 may be adhered, glued or attached to the base layer 102. Alternatively, the protrusions 104 may be formed by removal of material from a larger base layer 102, such as by laser cutting. The protrusions 104 may be spaced or positioned in such a way as to form one or more channels 106. The protrusions 104 may include a larger surface area in contact with a user and a smaller base in contact with the base layer 102 in order to create larger channels and increased user support.

The shape of the protrusions 104 may be of any shapes and dimensions suitable to support a user and provide one or more channels 106 with which to allow for air or fluid flow, or both. A rectangular-shaped protrusion 202 (FIG. 2) may also be utilized, such as in channeled mat with rectangular or squared protrusions 200.

The protrusions 104 may form a channeled layer and may form more than one layer. The channeled mat, protrusions 104, base layer 102, channeled layer or the combination thereof may be manufactured of a combination of materials, such as a composite or laminate. The channeled mat 100, 200 may be manufactured of thermosetting plastics or thermoplastics, for example.

Examples of a thermosetting plastic may include alkyd thermoset, diallyl phthalate (DAP, DAIP) thermoset, epoxy thermoset, melamine (MF, MPF) thermoset, urea (UF) thermoset, phenolic (phenol0-formaldehydes) thermoset, polybuatdiene (PBS, PBAN) thermoset, polyester (unsaturated, UP) thermoset, silicone (both flexible and rigid) thermoset, combinations thereof and laminates thereof.

Examples of a thermoplastic may include acrylonitrile-butadiene-styrene (ABS) amorphous thermoplastic, acetal (polyoxymethylene) (POM) semicrystalline thermoplastic, acrylic (polymethylmethacrylate) (PMMA) amorphous thermoplastic, cellulose acetate (CA) semicrystalline thermoplastic, cellulose acetate butyrate (CAB) semicrystalline thermoplastic, cellulose acetate proprionate (CAP) semicrystalline thermoplastic, ethyl cellulose (EC) semicrystalline thermoplastic, ethylene-vinyl acetate (EVA), polyaryl sulfone (PASU) amorphous thermoplastic, polycarbonate (PC) amorphous thermoplastic, polybutylene terephthalate (PBT) semicrystalline thermoplastic, polyethylene terphthalate (PET) semicrystalline thermoplastic, polyethersulfone (PES) amorphous thermoplastic, polyethylene (PE) semicrystalline thermoplastic, polypropylene (PP) semicrystalline thermoplastic, polyallomer (PAL) semicrystalline thermoplastic, polyimide (PI) amorphous thermoplastic, poly(amide-Imide) (PA-I) amorphous thermoplastic, polymethylpentene (PMP) semicrystalline thermoplastic, polyphenylene oxide (PPO) amorphous thermoplastic, polyphenylene sulfide (PPS) semicrystalline thermoplastic, polystyrene (PS) amorphous thermoplastic, polysulfone (PSU) amorphous thermoplastic, polyvinyl acetal semicrystalline thermoplastic, polyvinyl acetate (PVAC) seimcrystalline thermoplastic, polyvinyl alcohol (PVOH) semicrystalline thermoplastic, polyvinyl carbazole (PVK) semicrystalline thermoplastic, polyvinyl chloride (PVC) semicrystalline thermoplastic, polyvinyl chloride-acetate (PVAC) semicrystalline thermoplastic, polyvinylidene chloride (PVDC) semicrystalline thermoplastic, combinations thereof and laminates thereof.

The protrusions 104, base layer 102, channeled layer or channeled mat 100, 200 as a whole may also include plastics, such as fluorocarbons. Fluorocarbons may include tetrafluoroethylene (TFE), fluorinated ethylene propylene (FEP), ethylene-tetrafluoroethylene (ETFE) copolymer, perfluoroalkoxy (PFA) resin, chlorotrifluoroethylene (CTFE), ethylene-chlorotrifluoroethylene (E-CTFE) copolymer, vinylidene fluoride (PVF2), polyvinyl fluoride (PVF), combinations thereof and laminates thereof. The layer 104 may be manufactured of a plastic ionomer, such as Nylon (polyamide) (PA) semicrystalline thermoplastic, for example.

One example of a channeled mat 100, 200 may be manufactured of a composite foam including at least one of rubber and a resin, a blowing agent, a polymeric adhesion modifier, a decomposition accelerating agent, and a cross-linking agent. The composite foam may also be made up of at least one of natural rubber and an ethylene-vinyl acetate (EVA) copolymer, azodicarbonamide (AC), maleic anhydride graft (e.g., FUSABOND), dicumyl peroxide, and a combination of zinc oxide and stearic acid, for example. More specifically, the foam composite may be made up of natural rubber present in about 5 wt. % to about 12 wt. % of the foam composite, an ethylene-vinyl acetate (EVA) copolymer present in about 79 wt. % to about 83 wt. % of the foam composite, azodicarbonamide (AC) present in about 3 wt. % to about 4.2 wt. % of the foam composite, maleic anhydride graft (e.g., FUSABOND) present in about 2.8 wt. % to about 3.9 wt. % of the foam composite, dicumyl peroxide present in about 0.5 wt. % to about 0.9 wt. % of the foam composite and a combination of zinc oxide and stearic acid. The zinc oxide may be present in about 1.0 wt. % to about 2.2 wt. % of the foam composite and stearic acid may be present in about 0.5 wt. % to about 1.25 wt. % of the foam composite.

Further examples of materials that may be used as a channeled mat 100, 200 are discussed in Koffler, et. al., U.S. Pat. No. 6,818,676, entitled “FOAM CUSHION AND METHOD OF MAKING AND USING THE SAME,” filed Feb. 1, 2002, the disclosure of which is incorporated herein by reference in its entirety.

The channeled mat 100, 200 may have numerous uses, both for increased comfort and also for alleviating health or medical issues of a user. The channeled mat may be used as bedding, as part of a mattress, wall covering, flooring, seating, exercise mat, portable mat, cushion, furniture, floatation device, camping mat, beach chair, etc. Seating may include cushions, chairs, furniture, patio furniture, sports seating, portable or roll-up seating or lounge chairs. An exercise mat may include a workout mat, gymnastics or martial arts flooring/padding, weight lifting benches or stretching mats, for example. Examples of floatation devices may be pool and recreational floating mats and lounge chairs. The channeled mat 100, 200 may be miniaturized or enlarged to meet customized demands.

Depending on material and design, the channeled mat selectively can be water proof or liquid-absorbable, washable or non-washable, thermally stable or unstable, resistant to shrinkage or shrinkable, resistant to cracks or crackable, bendable or rigid, mold resistant or non-mold resistant, for example. The protrusions 104 may form a channeled layer. The protrusions 104 may also form all or part of a surface layer, in contact with a user.

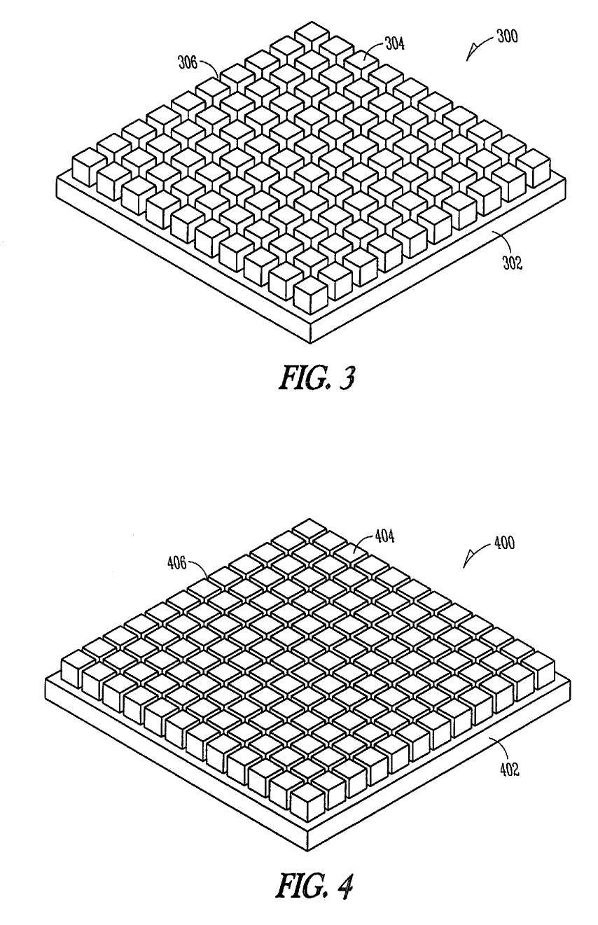

Referring to FIG. 3, a perspective view of a channeled mat 300 with rectangular protrusions is shown, according to some embodiments. Rectangular protrusions 304 may be in contact with a base layer 302, such as to form one or more channels 306. The position of the protrusions 304 may vary as to create different channel sizes 306 and surface contact characteristics for the user. The channeled mat 400 displays reduced channel 406 sizing (FIG. 4), in which the protrusions 404 in contact with the base layer 402 are nearly touching.

The protrusions 504 (FIG. 5) may form a continuous, semi-continuous, discontinuous or near-continuous surface layer in contact with a base layer 502, such that the channels 506 formed may be narrow and may not be readily apparent from looking at the surface of the channeled mat 500.

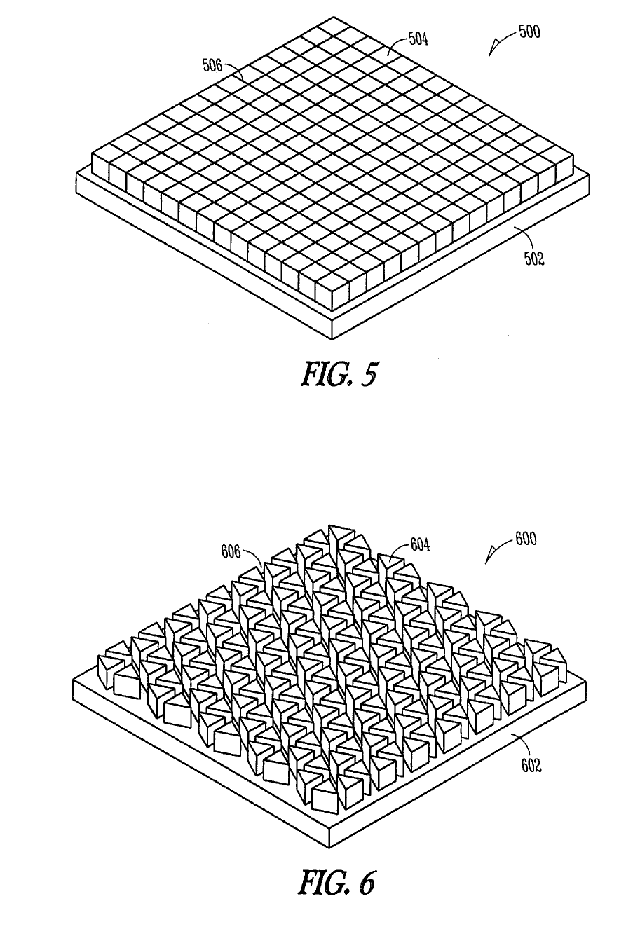

Referring to FIG. 6, a perspective view of channeled mat 600 with triangular shaped protrusions is shown, according to some embodiments. Triangular protrusions 604 may be contacted with a base layer 602, such as to form one or more channels 606.

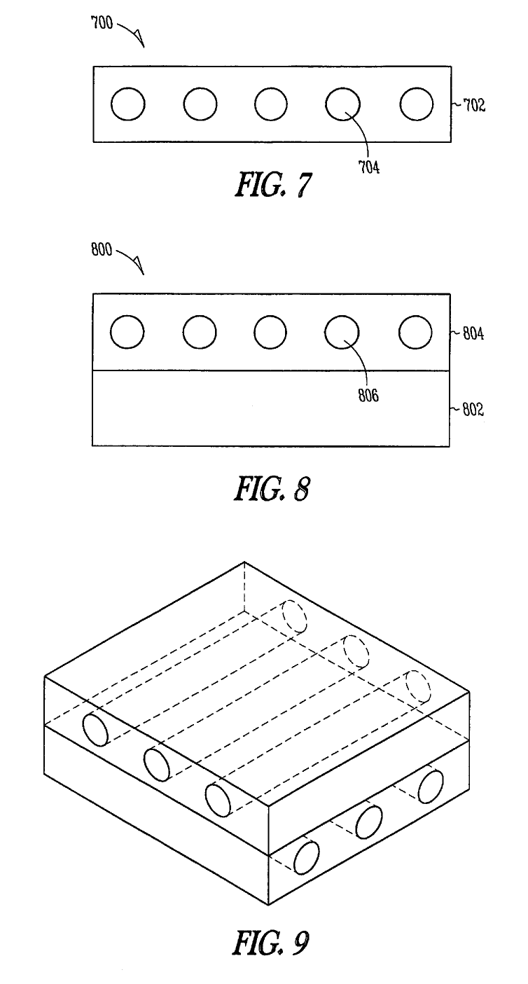

Referring to FIG. 7, a cross-sectional view a single layer channeled mat 700 is shown, according to some embodiments. A channeled layer 702 may include one or more channels 704. The channels 704 may be circular, cylindrical, tubular, rectangular or irregularly shaped, for example. The tubular channels may be bent or curved, for example. The base layer and channels 704 may form a single channeled layer.

Referring to FIG. 8, a cross-sectional view of a dual-layered channeled mat 800 is shown, according to some embodiments. A base layer 802 may be in contact with a channeled layer 804, including one or more channels 806. The channels 806 may be perpendicular, non-perpendicular, horizontal, vertical, skewed or a combination thereof, in relation to the other channels 806. The channels 806 may be formed such that gravity assists in moving fluids in a desired direction. An example would be channels 806 that are tilted downward or a portion of the channels 806 are positioned to move fluid or moisture away from the surface and to a desired exit or storage point.

Referring to FIG. 9, a perspective of a dual-layered channeled mat 900 with channels in multiple dimensions is shown, according to some embodiments. A base layer 904 containing channels 908 may be in contact with a second channeled layer 906. The second layer 906 may include channels 910 that run perpendicular to channels 908. Multiple layers may be stacked and channels may run in three dimensions, for example. Channels may connect the channeled structures of each individual layer together.

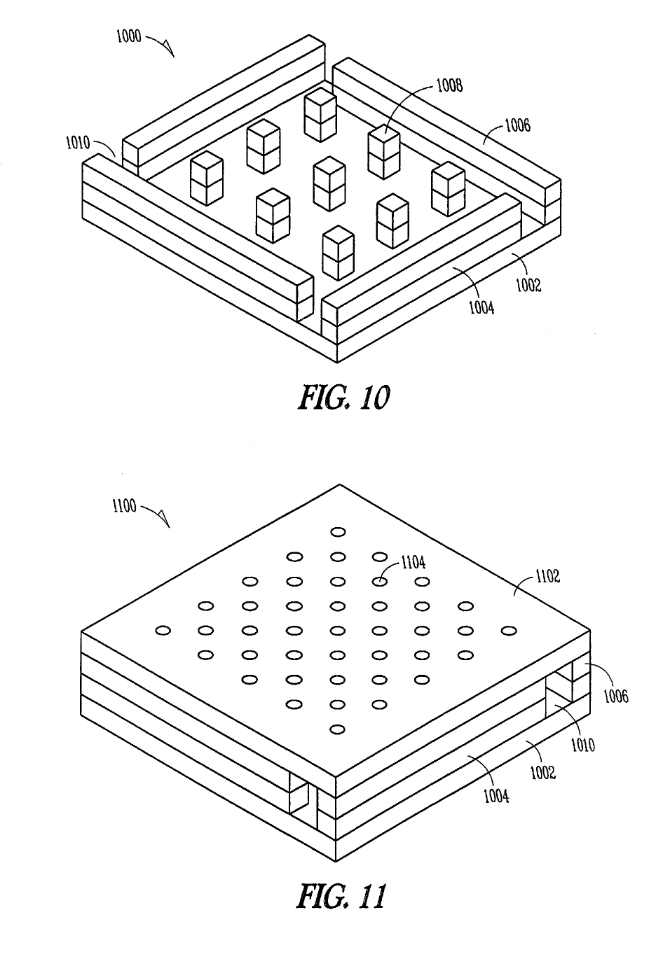

Referring to FIG. 10, a perspective view of an open ended channeled mat 1000 is shown, according to some embodiments. The base layer 1002 supports the one or more protrusions 1008. A second layer 1004 and optional third layer 1006 may be in contact with the perimeter of the base layer 1002. The third layer 1006 may be a surface layer. The layers (1002, 1004, 1006) may be contacted in a way to form one or more openings 1010. A cover 1102 may be positioned (See FIG. 11) in contact with the uppermost layer (e.g, layer 1006). The cover 1102 may include openings 1104.

Referring to FIG. 12, a perspective view of an aqueduct channeled mat 1200 is shown, according to some embodiments. A base layer 1202 may support one or more aqueduct-like structures 1204 that include one or more channels 1206. The aqueduct-like structures 1204 may be positioned parallel to one another, perpendicular to one another, some combination of both or positioned irregular angles to one another. The structures 1204 may also be stacked to form multiple channeled layers or a multi-tiered aqueduct-like channeled mat.

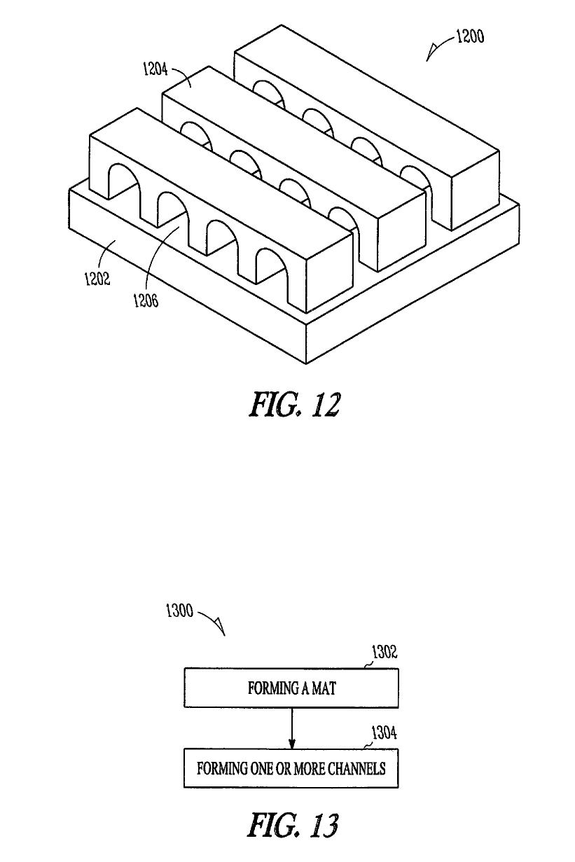

Referring to FIG. 13, a method 1300 of making a channeled mat is shown, according to some embodiments. A mat may be formed 1302. One or more channels may be formed 1304 in the mat. The mat may be formed before the channels are formed 1304 or simultaneously, for example. Forming may include attaching, contacting, cutting, adhering, drilling, extruding, profiling, etc.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

What is claimed is:

1. A channeled mat, comprising:
a mat; and
one or more channels in the mat.

2. The channeled mat of claim 1, wherein the mat comprises a base layer and one or more channeled layers.

3. The channeled mat of claim 2, wherein the one or more channels are positioned in the one or more channeled layers.

4. The channeled mat of claim 1, wherein the mat comprises a base layer, one or more channeled layers and surface layer.

5. The channeled mat of claim 4, wherein the surface layer is continuous at the user interface.

6. The channeled mat of claim 4, wherein the surface layer is discontinuous at the user interface.

7. The channeled mat of claim 4, wherein the surface layer is semi-continuous.

8. The channeled mat of claim 2, wherein the one or more channeled layers comprise protrusions.

9. The channeled mat of claim 2, wherein the one or more channeled layers comprise aqueduct-like structures.

10. The channeled mat of claim 8, wherein the protrusions are independent of one another.

11. The channeled mat of claim 8, wherein the protrusions are in contact with one another.

12. The channeled mat of claim 2, wherein the base layer and one or more channeled layers are of one-piece construction.

13. The channeled mat of claim 4, wherein the base layer, one or more channeled layers and surface layer are of one-piece construction.

14. The channeled mat of claim 1, wherein the one or more channels are cylindrical.

15. The channeled mat of claim 1, wherein the one or more channels are tubular.

16. The channeled mat of claim 2, wherein the one or more channeled layers are positioned perpendicular to adjacent channeled layers.

17. The channeled mat of claim 2, wherein the one or more channeled layers are positioned non-perpendicular to adjacent channeled layers.

18. The channeled mat of claim 1, wherein the channels are positioned horizontally, vertically, skewed or a combination thereof, in the channeled mat.

19. The channeled mat of claim 1, wherein the mat is manufactured of a composite or laminate.

20. The channeled mat of claim 1, wherein the mat is manufactured of a thermoplastic.

21. The channeled mat of claim 1, wherein the mat is manufactured of acrylonitrile-butadienc-styrene (ABS) amorphous thermoplastic, acetal (polyoxymethylene) (POM) semicrystalline thermoplastic, acrylic (polymethylmethacrylate) (PMMA) amorphous thermoplastic, cellulose acetate (CA) semicrystalline thermoplastic, cellulose acetate butyrate (CAB) semicrystalline thermoplastic, cellulose acetate proprionate (CAP) semicrystalline thermoplastic, ethyl cellulose (EC) semicrystalline thermoplastic, ethylene-vinyl acetate (EVA), polyaryl sulfone (PASU) amorphous thermoplastic, polycarbonate (PC) amorphous thermoplastic, polybutylene terephthalate (PBT) semicrystalline thermoplastic, polyethylene terphthalate (PET) semicrystalline thermoplastic, polyethersulfone (PES) amorphous thermoplastic, polyethylene (PE) semicrystalline thermoplastic, polypropylene (PP) semicrystalline thermoplastic, polyallomer (PAL) semicrystalline thermoplastic, polyimide (PI) amorphous thermoplastic, poly(amide-Imide) (PA-I) amorphous thermoplastic, polymethylpentene (PMP) semicrystalline thermoplastic, polyphenylene oxide (PPO) amorphous thermoplastic, polyphenylene sulfide (PPS) semicrystalline thermoplastic, polystyrene (PS) amorphous thermoplastic, polysulfone (PSU) amorphous thermoplastic, polyvinyl acetal semicrystalline thermoplastic, polyvinyl acetate (PVAC) seimcrystalline thermoplastic, polyvinyl alcohol (PVOH) semicrystalline thermoplastic, polyvinyl carbazole (PVK) semicrystalline thermoplastic, polyvinyl chloride (PVC) semicrystalline thermoplastic, polyvinyl chloride-acetate (PVAC) semicrystalline thermoplastic, polyvinylidene chloride (PVDC) semicrystalline thermoplastic, combinations thereof and laminates thereof.

22. The channeled mat of claim 1, wherein the mat is manufactured of a thermosetting plastic.

23. The channeled mat of claim 1, wherein the mat is manufactured of alkyd thermoset, diallyl phthalate (DAP, DAIP) thermoset, epoxy thermoset, melamine (MF, MPF) thermoset, urea (IF) thermoset, phenolic (phenol-formaldehydes) thermoset, polybuatdiene (PBS, PBAN) thermoset, polyester (unsaturated, UP) thermoset, silicone (both flexible and rigid) thermoset, combinations thereof and laminates thereof.

24. The channeled mat of claim 1, wherein the channeled mat is manufactured of a fluorocarbon.

25. The channeled mat of claim 1, wherein the channeled mat is manufactured of tetrafluoroethylene (TFE), fluorinated ethylene propylene (FEP), ethylene-tetrafluoroethylene (ETFE) copolymer, perfluoroalkoxy (PFA) resin, chlorotrifluoroethylene (CTFE), ethylene-chlorotrifluoroethylene (E-CTFE) copolymer, vinylidene fluoride (PVF2), polyvinyl fluoride (PVF), combinations thereof and laminates thereof.

26. The channeled mat of claim 1, wherein the channeled mat is manufactured of a foam composite.

27. The channeled mat of claim 1, wherein the channeled mat is manufactured of:
natural rubber present in about 5 wt. % to about 12 wt. % of the foam composite;
an ethylene-vinyl acetate (EVA) copolymer present in about 79 wt. % to about 83 wt. % of the foam composite;
azodicarbonamide (AC) present in about 3 wt. % to about 4.2 wt. % of the foam composite;
maleic anhydride present in about 2.8 wt. % to about 3.9 wt. % of the foam composite;
dicumyl peroxide present in about 0.5 wt. % to about 0.9 wt. % of the foam composite; and
a combination of zinc oxide and stearic acid;
wherein the zinc oxide may be present in about 1.0 wt. % to about 2.2 wt. % of the foam composite and stearic acid may be present in about 0.5 wt. % to about 1.25 wt. % of the foam composite.

28. The channeled mat of claim 1, wherein the mat comprises bedding, part of a mattress, wall covering, flooring, seating, exercise mat, portable mat, cushion, furniture, floatation device, camping mat, or beach chair.

29. The channeled mat of claim 1, wherein the mat comprises footwear.

30. The channeled mat of claim 1, wherein the mat comprises insoles.

31. The channeled mat of claim 28, wherein seating comprises cushions, chairs, furniture, patio furniture, sports seating, portable or roll-up seating or lounge chairs.

32. The channeled mat of claim 28, wherein an exercise mat comprises a workout mat, gymnastics or martial arts flooring/padding, weight lifting benches or stretching mats.

33. The channeled mat of claim 28, wherein a floatation device comprises pool and recreational floating mats and lounge chairs.

34. A method of making a channeled mat, the method comprising:
forming a mat, and
forming one or more channels in the mat.

35. The method of claim 34, wherein the mat comprises multiple layers.

36. The method of claim 34, wherein forming the one or more channels in the mat is simultaneous with the forming of the mat.
